(19) United States
(12) Patent Application Publication
(10) Pub. No.: US 2008/0120033 A1
(43) Pub. Date: May 22, 2008

(54) Method For Determining The Scope Of Detectability And Readability Of Light Signals

(75) Inventors: Thorsten Moller, Munchen (DE); Eckehard Wilhelm, Munchen (DE)

Correspondence Address: COLLARD & ROE, P.C., 1077 NORTHERN BOULEVARD, ROSLYN, NY, 11576, US

(73) Assignee: DEUTSCHE BAHN AG, Berlin (DE)

(21) Appl. No.: 11/666,387

(22) PCT Filed: Nov. 17, 2005
(86) PCT No.: PCT/EP05/12325

§ 371 Date: Apr. 26, 2007

(30) Foreign Application Priority Data
Nov. 17, 2004 (DE) 10 2004 055 536.2

(51) Int. Cl. G06F 19/00

(52) U.S. Cl. 702/1

(57) ABSTRACT

The invention relates to methods for determining the scope of detectability and readability of light signals with several light spots at a given surrounding radiant density per unit area. According to the invention, calculation of the scope of detectability is carried out with the rod of the assumption that the total radiant density per unit area or the total light intensity of the light signal is obtained by multiplying the radiant density per unit area or light intensity of a single light spot by the number of light spots.

### AREA OF THE INVENTION

The invention relates to optical measuring and testing methods with traffic signals, more preferably with light signals as they are used in rail traffic. More preferably the invention deals with methods for determining the scope of detectability and readability of a light signal with a prevailing background or also surrounding light density.

### BACKGROUND OF THE INVENTION

In rail traffic, signals are employed for regulating the traffic. As a rule, these are arranged at or above the tracks. The signals serve the tractive unit drivers of the trains as source of information concerning the traffic situation and enable smooth and safe rail traffic operation.

The signals can be designed as so-called semaphore signals. With semaphore signals, the signal term is indicated through a change of the shape of the signal. However, the semaphore signals have become outdated and are increasingly replaced with so-called light signals. With the light signals the signal term is indicated through a certain light emission of the light signal. With regard to the principle, such light signals are comparable with the traffic lights known from road traffic. A further introduction on the subject of light signals can be taken from the article “Grundsätzliches über Lichtsignale” (Fundamentals of light systems) by Dr. K. Grosskurth in Lichttechnik 8. No. 8 (1956).

A basic prerequisite for the use of a light signal in rail traffic is that it must be detectable or readable by the tractive unit drivers from an adequate distance, more preferably in daylight. In this context, a light signal is detectable as soon as it can be perceived by the tractive unit driver.

With complex light signals that represent symbols, readability is added to the prerequisite of detectablity. In fact it is not sufficient with these light signals that the tractive unit driver can recognize, i.e. perceive these. As soon as the vehicle driver has perceived the signal he must additionally be also in a position to read the symbol represented by the signal. The readability of a light signal is given if the symbol represented by said light signal is perfectly identifiable as a certain symbol. Accordingly, prerequisite for the readability of a signal initially is its detectability.

Accordingly, it must be guaranteed with light signals that these are detectable and readable respectively from various directions at least up to a certain minimum distance. In other words, light signals must have a certain minimum detection distance and if applicable also a certain minimum readability distance. To determine if this prerequisite for a given light signal is satisfied its detectability and readability distance therefore has to be determined.

The detection distance of a light signal is direction-dependent. Depending on the direction from which the light signal is seen a different detection distance is obtained. The detection distance for instance is greatest along the direction in which the light signal is aimed. This direction of the aim of the light signal is simultaneously the optical axis of the light signal.

On the other hand for instance the detection distance of the light signal is obviously equal to zero if it is viewed from its back. Since the detection distance of a signal depends on the direction of viewing a different detection distance is obtained for every direction so that on the whole a detection distance distribution is present.

The detection distance for a given direction is defined as the distance along this direction up to which the light signal can still be perceived at a prevailing surrounding or also background radiant density per unit area. The detection distance of a light signal can also be called the range of the light signal.

The readability distance of the symbol of a light signal is defined for a given direction as the distance along this direction up to which the symbol with a prevailing surrounding or also background radiant density per unit area can still be identified.

From the article “Tragweite von Lichtsignalen” (Range of light systems) by Dr. K. Grosskurth in Lichttechnik 9. No. 11 (1957) a method is known with which the detection distances of a light signal, which consists of a single light spot, can be determined. A significant disadvantage of this known method is that it does not make possible determining the detection distances of light signals that consist of several light spots. More preferably, with this method, the detection distances of self-illuminating additional indicators as increasingly used in rail traffic cannot be determined. In fact, these additional indicators have several light spots by means of which different symbols can be represented.

As for the rest, no method is known as yet with which the readability distance of a light signal can be determined.

### OBJECT OF THE INVENTION

In view of the problems of the prior art just related it is an object of the present invention to suggest methods for determining the detectability and readability distance with light signals, more preferably with light signals with several light spots.

### DESCRIPTION OF THE INVENTION

According to the invention, this object is solved through a method for determining the detection distance of a light signal present in a given direction and comprising several light spots with a prevailing surrounding radiant density per unit area with the following steps:

Measurement of the radiant density per unit area or light intensity of each individual light spot present in the given direction and calculation of the detection distance based on the measured radiant densities or light intensities with the help of the threshold values calculated from these measured values for the total radiant density per unit area or the total light intensity of the light signal which is obtained through multiplication of the radiant density per unit area or light intensity of an individual light spot with the number of the light spots and with a correction factor. This correction factor depends on the number of light spots, on light intensity, the diameter and the position of each of the light spots and on the distances that prevail between the light spots relative to one another. More preferably the correction factor is always smaller or equal to 1.

The cause of the varying correction factors are depicting characteristics of the eye:
During the day, the light spots are depicted as small diffraction slices on the retina of the eye because of the diffraction of the light entering the eye on the pupil of the eye, so that the correction value is 1.
In twilight and at night a blurred depiction of the light spots as slices on the retina of the eye results so that the correction factor is smaller than 1. Blooming of the individual light spots occurs.
During the day and more preferably at night scattering of suspended particles in the fluid of the eye within the eyeball additionally occurs so that the correction factor is smaller than 1. The occurrence of suspended particles in the eye is more preferably a phenomenon of the age of the eye or pathological.

Increasing the practical readability distance or increasing the readability is possible by taking into account the first two root causes. However, healthy vision of the beholder, i.e. preferably the third root cause which hardly ever appears/acts, is required. Advantageously, this correction factor is determined numerically. To do so, a virtual additional indicator is given with user-defined light spot arrangement and the correction factor calculated by means of an eye model, more preferably the Gullstrand eye model and light ray calculation with given distance between eye and additional indicator. The virtual additional indicator is depicted in that a virtual grid with freely selectable positions is occupied with light spots.

Blooming increases with the distance to the signal consisting of several light spots since the angle between each two adjacent light spots decreases with the distance from the signal. To improve the readability or to realize a greater practical readability distance up to the amount of the theoretical readability distance, the distance between every two adjacent light spots is to be increased, as a result of which the range of the signal can be reduced however.

The method according to the invention is also applicable if the total radiant density per unit area or the total light intensity is not inversely proportional to the number of the light spots, e.g. proportional to a power of the number of light spots.

The formulation “Distance to one another” chosen above in this case serves to explain that this is the distance of a light spot to any other light spot of the light signal. In contrast with this, “Distance from one another” indicates the distance of a light spot to its next adjacent light spot.

The light spots of the light signal can also be largely described as point light sources. Preferably the light signal is formed through the totality of the light spots. In this way the light spots altogether can depict in their geometrical arrangement a certain symbol such as for example a piece of speed information. If the light spots are then illuminated jointly, this results in a radiant symbol that can serve as source of information for a tractive unit driver.

Measuring the radiant density per unit area or the light intensity of each light spot is performed by way of a commercially available measuring device. Here, measurement has to be performed differently depending on the measuring device used. If for example a device is used that measures individual mean radiant densities per unit area or light intensities directly, the device is aligned from a certain direction with the corresponding light spot of the light signal and the mean radiant density per unit area or light intensity collected by the device is recorded.

If for example a measuring camera for the measurement of radiant density per unit area or light intensity distributions is used, the camera is aligned with the total light signal from a known distance and the radiant density per unit area or light intensity distribution of the total signal is recorded. Using the measured distribution, the values can then be determined for the individual light spots.

In calculating the detection distance with the help of the threshold value for the total radiant density per unit area and the total light intensity respectively it is assumed that the threshold value for the total radiant density per unit area and the total light intensity respectively of the light signal is the product of the radiant density per unit area or light intensity respectively of a light spot with the number of the light spots and the correction factor.

The assumption just described more preferably applies to larger distances (i.e. more than 10 m) from the light signal concerned or to a certain maximum distance of the light spots relative to one another.

It is an advantage if during the measurement of the radiant density per unit area of a light spot the radiant density per unit area is measured both in the switched on state and also in the switched off state. Here, the radiant density per unit area measured in the switched on state is the sum of the pure radiant density per unit area caused by the light spot and the surrounding radiant density per unit area that prevails during the measurement. The radiant density per unit area measured in the switched off state in contrast only consists of the surrounding radiant density per unit area. Consequently by forming the difference of the two measured values the surrounding radiant density per unit area can be removed from the measured values so that merely the pure radiant density per unit area of the light spot is retained, i.e. the radiant density per unit area of the switched on light spot with completely dark surroundings.

Preferably the radiant density per unit area differential obtained by forming the differential is converted to the optical axis of the light signal. This is necessary if the measurement of the radiant density per unit area did not take place along the optical axis of the light signal and the detection distance in direction of the optical axis is to be determined.

From the radiant density per unit area differential along the optical axis, which corresponds to the pure radiant density per unit area of the light spot along the optical axis, a standardized radiant density per unit area can be calculated by adding a defined surrounding radiant density per unit area or also background radiant density per unit area. Preferably the defined background radiant density per unit area is an established value which prevails under the most difficult light conditions, i.e. under conditions in which light signals are particularly difficult to detect. This is the case for instance in bright sunshine in a snowy landscape. Preferably the defined background radiant density per unit area has a value of around 10000 cd/m².

The object mentioned at the outset is also solved through a method for determining the readability distance prevailing in a given direction of a symbol of a traffic signal with a given surrounding radiant density per unit area with the following steps:

Determination of the characteristic length of the symbol, determination of the required minimum angle of vision of the eye with the given surrounding radiant density per unit area and calculation of the readability distance using the established characteristic length and the established required minimum angle of vision.

The symbol of the traffic signal can be any geometrical figure which is suitable to instruct a tractive unit driver. More preferably the symbol is a letter or a numeral.

The minimum angle of vision is the smallest angle the eye can resolve on viewing. Objects that can be seen under an angle smaller than the minimum angle of vision can no longer be perceived in a differentiated manner by the eye. The minimum angle of vision is also called “Ricco's critical angle” and depends on the surrounding radiant density per unit area. Preferably the characteristic length of the symbol is the length whose resolution through the eye is prerequisite for the reading of the symbol.

Preferably the readability distance is determined in the direction of the optical access of the traffic signal.

If the readability distance is not determined in the direction of the optical axis, the angle between the optical axis and the relevant direction will have to be taken into account under certain conditions when determining the characteristic length.

Preferably the symbol consists of several elements. If the symbol consists of several elements and the readability is determined in the direction of the optical axis of the traffic signal, the characteristic length of the symbol is defined as follows:
1. With a dark section, by the distance between the light spots forming the boundary of the dark section;
2. With a radiant section, by the distance between the outer light spots belonging to the radiant section.

The elements in their totality form the symbol. The elements can more preferably be individual light spots.

The traffic signal is preferably a light signal, more preferably an additional light signal.

The described methods according to the invention make possible accurate and reliable determination of the detectability and readability distances of traffic signals, more preferably with light signals consisting of several light spots. In this way, traffic signals that are in operation or prototypes can be checked for their detectability and readability. For example, old traffic signals which from the distance are no longer adequately detectable or readable can be easily detected and replaced. This increases the safety of the traffic system.

Special advantages of the invention are:
Improvement of the readability and realizing a greater practical readability distance (of the amount of the theoretical readability distance) or reduction of the energy requirement for the light spots for achieving the required readability distance and range: of the speed and direction indicators make Siemens that are present on the open sections in the area of the Deutsche Bahn AG by using other grid insert board positions for the light conductor light emission surfaces;
Achievement of preferably good readability and realization of a preferably large practical readability distance (in the ideal case of the amount of the theoretical readability distance) with simultaneous expenditure/use of a preferably low energy requirement for the light spots for achieving the required readability distance and range: of new LED additional indicators still to be employed by specifying the number of light spots, the diameter and the light intensity of an individual LED light spot as well as the position of each of the light spots.
Obsolescence of test subject trials for determining the readability distances and ranges of additional indicators by determining these quantities from the light distributions of the additional indicators measured in the light measuring section analog to the procedure with the light distributions of the individual signals/light spots measured for determining the ranges of individual signals/light spots through determining these quantities.

The invention is explained in more detail in the following by means of two embodiments and a drawing with a figure. The figures show in

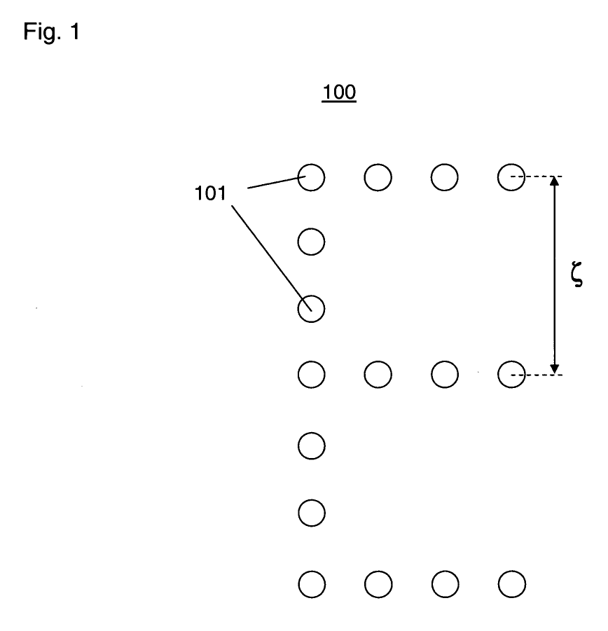

FIG. 1 schematically an additional indicator, whose 16 figure spots represent a letter “E”.

### DESCRIPTION OF PREFERRED EMBODIMENTS

In the following, a preferred embodiment each of the method according to the invention for determining the detectability and the readability of a light signal is described.

With a self-radiating additional indicator, which has been in operation on a rail section for 15 years, the detectability and the readability distance is to be determined. The symbol 100, indicated by this additional indicator, is shown in FIG. 1. It is the letter “E”. The symbol 100 consists of 16 light spots 101. If these are jointly switched on a radiant “E” is obtained as a result.

### Determining the Detection Distance

To determine the detection distance tₙ of the radiant symbol 100 and thus the switched-on additional indicator for a certain direction, the mean radiant density per unit area of each light spot 101 is initially measured from this direction. To do so, a suitable radiant density per unit area measuring device is aligned with each of the individual light spots and the resultant measured value read off. Here, the measurement is performed such that an angle α exists between the optical axis of the additional indicator and the line between the measuring device and the penetration point of the optical axis at the front of the additional indicator.

The light density Lₒₙ in the switched-on and L_{off} in the switched-off state is measured for each light spot. Consequently two measured values Lₒₙ and L_{off} are obtained for each of the 16 light spots. From these two measured values the radiant density per unit area differential ΔLₐ=Lₒₙ−L_{off} is then formed in each case.

After this, ΔLₐ is converted to a radiant density per unit area differential along the optical axis ΔLₒ_{^{∘}}. This is performed with the following formula:

ΔLₒ_{^{∘}}=ΔLₒ·k·cos(α) (1)

Here, k is the ratio between the maximum light intensity and the light intensity with the angle α against the optical axis of the additional indicator. K is determined from the additionally measured light distribution of the additional indicator.

Following this, the mean standardized radiant densities Lₙ of the light spots for distances over 100 m are determined by way of the following equation:

Lₙ=ΔLₒ_{⁺}+L_{H} (2)

Here, L_{H} is the background radiant density per unit area. For this, the value 10000 cd/m² is assumed which corresponds to the most difficult surrounding light conditions. With this conversion one obtains 16 radiant densities Lₙ standardized to a single common background radiant density per unit area.

Furthermore, a common mean value Lᵢ is calculated from the sixteen standardized light densities Lₙ. This common mean value constitutes the average radiant density per unit area of any of the sixteen light spots in direction of the optical axis. This value can finally be substituted in the following formula for the detection range tₙ of the additional indicator:

$${t}_{o} = \sqrt{\frac{ϕ \cdot 2 \cdot A \cdot {L}_{i}}{\frac{4 \cdot {10}^{- 7}}{n} \cdot {L}_{H}}}$$

Here, φ is the correction factor, A is the cross sectional area of a light spot and n the number of existing light spots, i.e. sixteen in this example. This central formula (3) is known for φ=1 and n=1, i.e. for light signals with only one light spot. So far unknown however is the insertion of the factors n and above all φ, which make possible the exact calculation of the detection distance also for light signals with several randomly arranged light spots. The insertion of the factor n is based on the knowledge that the light intensity required by each individual light spot for a certain total light intensity (light intensity is radiant density per unit area times surface) of the light signal is inversely proportional to the number n (n=16 in the present example) of the light spots.

The correction factor φ reflects the dependency of the threshold value for the total radiant density per unit area of the signal on the number of light spots, on the light intensity, the diameter and the position of each of the light spots and on the prevailing distances to one another between the light spots, while the factor 2 describes the influence of the signal screen present with most light signals on the signal during the day. To determine the detection distances of a light signal at night or in a tunnel the factor 1000 must be inserted in the above formula instead of the factor 2.

The formula (3) can also be expressed as follows making use of the light intensity Iₙ of a light spot (Iₙ=A·Lᵢ):

$${I}_{n} = \frac{\frac{{E}_{min}}{n} \cdot {L}_{H} \cdot {t}_{o}^{2}}{ϕ \cdot 2} ∝ \frac{1}{n}$$

with the threshold value Eₘᵢₙ for the radiant intensity. By means of this equivalent formula (4), the inverted proportionality between the light intensity Iₙ and n is immediately evident.

It was discovered that the new type of formula (3) for tₙ and the equivalent formula (4) for Iₙ can be applied to any distances of the light spots from one another.

The detection distance tₙ determined via formula (3) can then be compared with the permissible minimum value for the detection distance in the concrete case. In this way it can then be determined if the measured additional indicator is still adequately detectable or has to be replaced.

### Establishing the Readability Distance

If the symbol 100 of the additional indicator is timely detected by the tractive unit driver this does not yet mean however that he is also timely able to read it. In order to make it possible that the perceived symbol 100 can be read as well, it must be additionally possible to be resolved by the eye. For as long as the symbol 100 is only seen as a blurred patch of light and not as “E”, the additional indicator is in fact detected but it cannot yet be read. Thus, with an additional indicator, not only a certain detection distance but also a certain readability distance must be guaranteed. Just like the detection distance, the readability distance depends on the direction from which the symbol to be read is viewed.

In the following it is now described how, for the additional indicator with the symbol 100, the readability distance I along this optical axis is determined. The readability distance along the optical axis simultaneously is also the maximum readability distance.

The readability distance I of the symbol 100 along the optical axis of the additional indicator can be determined by means of the following formula:

I=(ζ/2)/(tan(γ/2)) (5)

Here, γ is the minimum value for the angle of vision from which an observer is able to read or resolve a symbol with a given surrounding radiant density per unit area. γ is also described as “Ricco's critical angle” and can be looked up for a known surrounding radiant density per unit area. With average daylight a value of approximately 1′ is obtained for γ.

A background radiant density per unit area corresponds to each blur disc in the immediate vicinity of the respective light spot.

The theoretical readability distance is a function of the surrounding radiant density per unit area which in this case is the mean value of the background radiant density per unit area and the radiant density per unit area in the immediate vicinity of the light spots weighted with the respective area components.

ζ is the characteristic length of the symbol and in the case of symbol 100 can be taken from the figure.

As a matter of principle, the characteristic length with a certain symbol is the length, whose resolution through the eye is the prerequisite for the reading of the symbol.

For any symbol that consists of several light spots the characteristic length of the symbol is defined as follows:
1. With a dark section, by the distance between the light spots forming the boundary of the dark section;
2. With a radiant section, by the distance between the outer light spots belonging to the radiant section.

If the readability distance is to be determined along a direction other than that of the optical axis, the angle between the relevant direction and the optical axis will have to be additionally considered in the given formula.

In summary, the maximum readability distance of a light signal can be determined by means of the characteristic length of the symbol which is obtained directly from the geometric configuration of the symbol and by means of the looked-up minimum angle of vision with the mentioned formula for a known surrounding radiant density per unit area.

As soon as the readability distance of a signal has been determined with the described method, it can be immediately assessed, through comparison with permissible minimum values, if the signal has adequate readability.

### LIST OF REFERENCE NUMBERS

100 symbol
101 light spot

### INDEX OF FORMULA SYMBOLS USED

α angle
Lₒₙ radiant density per unit area in switched-on state
L_{off} radiant density per unit area in switched-off state
ΔLₒ radiant density per unit area differential
Δlₒ_{^{∘}} optical axis
k ratio between the maximum light intensity and the light intensity with the angle α with the optical axis of the additional indicator
Lₙ mean standardized radiant density per unit area
L_{H} background radiant density per unit area
Lᵢ common mean value of all mean standardized radiant densities Lₙ
tₙ detection distance
φ correction factor
A cross sectional area of a light spot
n number of existing light spots
Iₙ light intensity of a light spot
Eₘᵢₙ threshold value for the radiant density per unit area
I readability distance
ζ characteristic length
Y minimum value for the angle of vision from which an observer can read or resolve a symbol with a given surrounding radiant density per unit area

1. A method for determining the detection distance prevailing in a given direction of a light signal comprising several light spots with an established surrounding radiant density per unit area with the following steps:
measurement of the radiant density per unit area or light intensity prevailing in the given direction of each individual light spot and
calculation of the detectability and readability distance based on the measured radiant densities or light intensities,
wherein
the calculation of the detection distance is performed with the help of the threshold value for the total radiant density per unit area or the total light intensity of the light signal which is obtained through multiplication of the measured radiant density per unit area or light intensity of an individual light spot with a power of the number of light spots and with a correction factor.

2. The method according to claim 1, wherein the correction factor depends on the number of light spots, on the light intensity, the diameter and the position of each of the light spots and on the prevailing distances to one another between the light spots.

3. The method according to claim 2, wherein the correction factor is determined numerically.

4. The method according to claim 3, wherein a virtual additional indicator with user-definable light spot arrangement is specified and the correction factor is calculated by means of an eye model and light beam calculation with given distance between eye and additional indicator.

5. The method according to claim 4, wherein the virtual additional indicator is formed in that a virtual grid with freely selectable positions is occupied with light spots.

6. The method according to claim 1 with the further steps:
Measurement of a first radiant density per unit area for each individual light spot in the switched-off state of the light signal and
Measurement of a second radiant density per unit area for each individual light spot in the switched-off state of the light signal.

7. The method according to claim 6 with the further step:
calculation of the radiant density per unit area differential of each light spot along the optical axis of the light signal by means of the measured first and second radiant densities.

8. The method according to claim 7 with the further step:
Calculation of the standardized radiant density per unit area of each light spot through addition of the radiant density per unit area differential calculated in each case to the established surrounding radiant density per unit area.

9. The method according to claim 1, wherein upon measurement of the radiant density per unit area or the light intensity a mean radiant density per unit area or a mean light intensity is measured.

10. The method according to claim 1, wherein during the measurement of the radiant density per unit area or the light intensity a radiant density per unit area distribution or a light intensity distribution is measured.

11-15. (canceled)
